(19) United States
(12) Patent Application Publication
(10) Pub. No.: US 2018/0255224 A1
(43) Pub. Date: Sep. 6, 2018

(54) ILLUMINANCE ACQUISITION DEVICE, ILLUMINATION CONTROL SYSTEM, AND PROGRAM

(71) Applicant: PANASONIC INTELLECTUAL PROPERTY MANAGEMENT CO., LTD., Osaka (JP)

(72) Inventors: Sho IKEMURA, Mie (JP); Yasuhiro MORI, Osaka (JP); Mutuhiro YAMANAKA, Osaka (JP); Toshiharu TAKENOUCHI, Osaka (JP)

(21) Appl. No.: 15/760,123

(22) PCT Filed: Sep. 12, 2016
(86) PCT No.: PCT/JP2016/004131

§ 371 Date: Mar. 14, 2018

(30) Foreign Application Priority Data
Sep. 24, 2015 (JP) 2015-187095

(51) Int. Cl. H04N 5/235; G03B 15/02

(52) U.S. Cl. CPC H04N 5/2354; H04N 5/2351; G03B 15/02

(57) ABSTRACT

The illuminance acquisition device includes a setting unit, a human sensing unit, and an illuminance acquisition unit. The setting unit sets an illuminance acquisition area (as a first area) for use to acquire an illuminance in an image capturing area of an image capturing unit. The human sensing unit determines, based on an image captured by the image capturing unit, whether or not there is any human in a human sensing area (as a second area) of the image capturing area. The illuminance acquisition unit calculates, based on the image, a spatial illuminance in the first area.

### TECHNICAL FIELD

The present invention relates to illuminance acquisition devices, illumination control systems, and programs.

### BACKGROUND ART

A device for calculating (and acquiring data about), based on an image captured, the illuminance of a shooting space where an object of shooting is located has been known in the art (see Patent Literature 1, for example).

An information processor as disclosed in Patent Literature 1 obtains an index value to a sense of brightness in the shooting space by processing an image representing the distribution of illuminance measured in an image capturing area of a camera.

The shooting space may sometimes cover a window and/or a TV, for example. In such a situation, the brightness of a view of the outdoors through the window or the brightness of video on the TV may vary often. That is why if the shooting space covers a window or a TV, then the luminance (pixel value) of its image varies too frequently to calculate (or obtain) the brightness appropriately.

### CITATION LIST

### Patent Literature

Patent Literature 1: JP 2013-168333 A

### SUMMARY OF INVENTION

It is therefore an object of the present invention to provide an illuminance acquisition device, illumination control system, and program with the ability to reduce an error in illuminance detected from an image.

An illuminance acquisition device according to an aspect of the present invention includes a setting unit, a human sensing unit, and an illuminance acquisition unit. The setting unit is configured to set a first area for use to acquire an illuminance in an image capturing area of an image capturing unit. The human sensing unit is configured to determine, based on an image captured by the image capturing unit, whether or not there is any human in a second area of the image capturing area. The illuminance acquisition unit is configured to acquire, based on the image, a spatial illuminance in the first area.

An illumination control system according to another aspect of the present invention includes the illuminance acquisition device described above, a lighting fixture, and a controller. The controller is configured to, when the illuminance acquisition device has detected presence of any human, control light output of the lighting fixture based on the illuminance acquired by the illuminance acquisition device.

A program according to still another aspect of the present invention is designed to make a computer function as a setting unit, a human sensing unit, and an illuminance acquisition unit. The setting unit is configured to set a first area for use to acquire an illuminance in an image capturing area of an image capturing unit. The human sensing unit is configured to determine, based on an image captured by the image capturing unit, whether or not there is any human in a second area of the image capturing area. The illuminance acquisition unit is configured to acquire, based on the image, a spatial illuminance in the first area.

The illuminance acquisition device, illumination control system, and program described above allows for reducing an error in illuminance detected from an image.

### BRIEF DESCRIPTION OF DRAWINGS

FIG. 1 is a block diagram illustrating a configuration for an illumination control system and illuminance acquisition device according to a first embodiment;

FIG. 2 illustrates an illuminance acquisition area and human sensing area according to the first embodiment;

FIG. 3 illustrates an area setting function of a setting unit according to a second embodiment;

FIGS. 4A-4C illustrate how to set an illuminance acquisition area based on a degree of variation in pixel value; and

FIGS. 5A and 5B illustrate how to set an illuminance acquisition area based on a histogram of pixel values.

### DESCRIPTION OF EMBODIMENTS

The following embodiments generally relate to illuminance acquisition devices, illumination control systems, and programs, and more particularly relate to an illuminance acquisition device, illumination control system, and program for acquiring data about the illuminance of a shooting space by using an image captured.

### First Embodiment

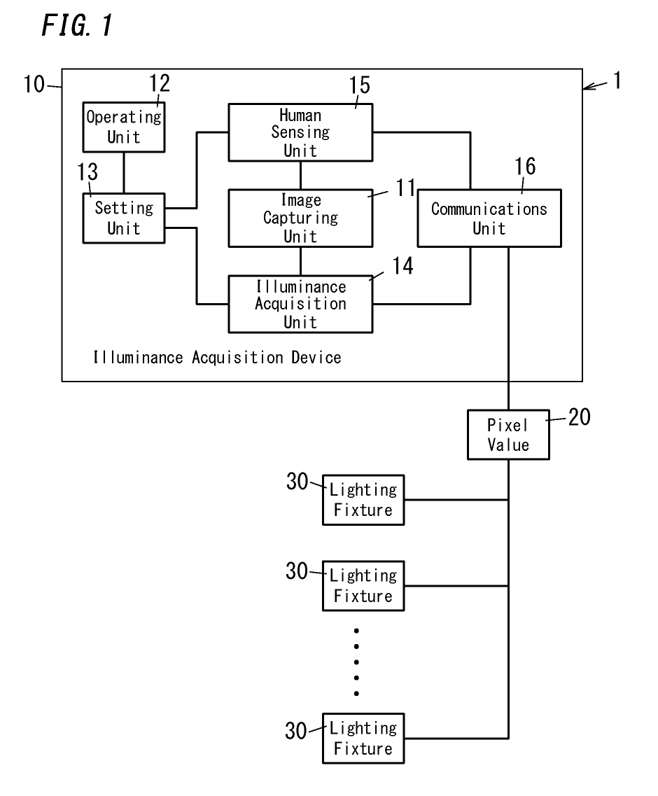

A first embodiment of an illumination control system 1, illuminance acquisition device 10, and program will now be described with reference to FIGS. 1-3.

As shown in FIG. 1, the illumination control system 1 includes an illuminance acquisition device 10, a controller 20, and a plurality of lighting fixtures 30. Alternatively, only one lighting fixture 30 may be provided.

The illuminance acquisition device 10 is a device with the function of acquiring data about the illuminance of a shooting space based on an image captured (hereinafter referred to as a “first processing function”) and the function of determining whether or not there is any human in the shooting space (hereinafter referred to as a “second processing function”). The controller 20 is a device for controlling the light output of the plurality of lighting fixtures 30 based on a processing result of the first processing function and a processing result (sensing result) of the second processing function.

A configuration for the illuminance acquisition device 10 will be described. As shown in FIG. 1, the illuminance acquisition device 10 includes an image capturing unit 11, an operating unit 12, a setting unit 13, an illuminance acquisition unit 14, a human sensing unit 15, and a communications unit 16.

The setting unit 13, the illuminance acquisition unit 14, and the human sensing unit 15 include, as their major component, a microcomputer (or microcontroller), and perform these functions by executing a program stored in a memory. Note that the program may have been written in a memory in advance or may be provided after having been stored in a storage medium such as a memory card.

The image capturing unit 11 is a two-dimensional image sensor with a solid-state image sensor in which a plurality of photodetectors are arranged two-dimensionally. The photodetectors may be implemented as charge coupled devices (CCDs) or complementary metal oxide semiconductor (CMOS) devices, for example. The image capturing unit 11 outputs an image captured to the illuminance acquisition unit 14 and the human sensing unit 15.

The operating unit 12 may be implemented as a remote controller, which accepts an operating command input and outputs an operating signal representing the operating command input and which includes a display screen with a touchscreen capability. The operating unit 12 accepts the operating command input by the operator to make the setting unit 13 set an illuminance acquisition area (first area) for use to acquire the illuminance in the shooting area. In addition, the operating unit 12 also accepts the operating command input by the operator to make the setting unit 13 set a human sensing area (second area) for use to detect the presence of any human in the shooting area. On the display screen of the operating unit 12, a pixel-by-pixel image capturing area (corresponding to the shooting area) may be displayed on a pixel-by-pixel basis. The operator is allowed to specify an illuminance acquisition area by touching the screen on the pixels to define the illuminance acquisition area. The operating unit 12 outputs, as an operating signal, information indicating the locations of all pixels specified as defining the illuminance acquisition area through the operating command input (e.g., the coordinates of the specified pixels), to the setting unit 13 as an infrared ray. In addition, the operator also touches the screen on the pixels to define the human sensing area, thereby specifying the human sensing area. The operating unit 12 outputs, as an operating signal, information indicating the locations of all pixels specified as defining the human sensing area through the operating command input (e.g., the coordinates of the specified pixels), to the setting unit 13 as an infrared ray. Note that the operating unit 12 may specify each of these areas on a pixel-by-pixel basis or on the basis of a rectangular area composed of plurality of pixels, without particular limitation.

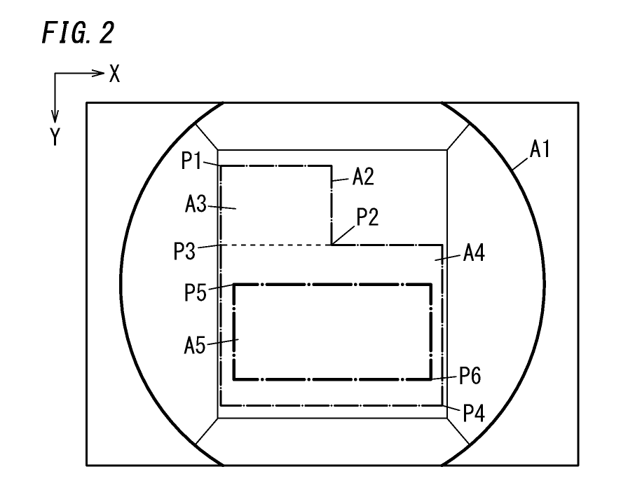

The setting unit 13 sets the illuminance acquisition area and the human sensing area in accordance with the operating command input by the operator through the operating unit 12 (i.e., in accordance with the operating signal supplied from the operating unit 12). For example, if an area A2 has been specified as the illuminance acquisition area in the image capturing area A1 in accordance with the operating command input by the operator (see FIG. 2), then the setting unit 13 stores information about rectangular areas A3 and A4 that form the area A2. More specifically, the setting unit 13 stores a first set of coordinates PP1 consisting of starting coordinates P1 and ending coordinates P2 that define the area A3, and a second set of coordinates PP2 consisting of starting coordinates P3 and ending coordinates P4 that represent the area A4. This allows the setting unit 13 to set the illuminance acquisition area. Also, if an area A5 has been specified as the human sensing area in the image capturing area A1 in accordance with the operating command input by the operator (see FIG. 2), then the setting unit 13 stores a third set of coordinates PP3 consisting of starting coordinates P5 and ending coordinates P6 that define the area A5. This allows the setting unit 13 to set the human sensing area.

The illuminance acquisition unit 14 performs calibrations while the illuminance acquisition device 10 is installed, thereby calculating and storing a transform coefficient for transforming the luminance of an image into an illuminance thereof. Specifically, the illuminance acquisition unit 14 calculates the transform coefficient by the equation “transform coefficient=(exposure duration×gain×brightness coefficient)/luminance of image,” where the brightness coefficient is a value measured with an illuminometer.

The illuminance acquisition unit 14 calculates and acquires the illuminance of a shooting space based on the brightness values (pixel values) of all pixels included in the illuminance acquisition area that has been set by the setting unit 13. Specifically, the illuminance acquisition unit 14 stores correction coefficients α1, β1, and γ1 for an R luminance (R1), a G luminance (G1), and a B luminance (B1), respectively. The illuminance acquisition unit 14 obtains, for each of the plurality of pixels included in the illuminance acquisition area represented by a single set or plural sets of coordinates stored in the setting unit 13, an R luminance (R1), a G luminance (G1), and a B luminance (B1) associated with that pixel. For example, if the illuminance acquisition area is the area A2 shown in FIG. 2, then the illuminance acquisition unit 14 obtains R, G, and B luminance values associated with all pixels included in the rectangular area A3 defined by the first set of coordinates PP1 and the rectangular area A4 defined by the second set of coordinates PP2. The illuminance acquisition unit 14 respectively corrects, with the correction coefficients α1, β1, and γ1, those R1, G1, and B1 values thus obtained, thereby calculating a corrected R luminance (R2), a corrected G luminance(G2), and a corrected B luminance (B2). That is to say, R2=R1×α1, G2=G1×β1, and B2=B1×γ1. The illuminance acquisition unit 14 calculates, for each of the plurality of pixels included in the illuminance acquisition area, the pixel value of that pixel based on the corrected luminance of that pixel. In this case, the pixel value is calculated by “pixel value=(R2+G2+B2)/(exposure duration×gain).”

The illuminance acquisition unit 14 also calculates a representative value based on the pixel values that have been calculated on a pixel-by-pixel basis in the illuminance acquisition area (e.g., the area A2 in this case). Specifically, the illuminance acquisition unit 14 calculates the average of all pixel values calculated and sets the average thus calculated as the brightness (luminance) of the image. Alternatively, instead of calculating such an average as the representative value, the illuminance acquisition unit 14 may also regard, as the representative value, a median or mode with respect to all of those pixel values calculated.

The illuminance acquisition unit 14 calculates the illuminance by multiplying, by the transform coefficient stored in advance, the image luminance thus calculated. Then, the illuminance acquisition unit 14 outputs the illuminance, calculated based on the image luminance, to the controller 20 via the communications unit 16.

The human sensing unit 15 determines, within the human sensing area set by the setting unit 13, whether or not there is any human in the shooting space. Specifically, in accordance with the information provided by the image capturing unit 11, the human sensing unit 15 corrects the image captured by the image capturing unit 11 into an image for sensing any human. The human sensing unit 15 stores in advance, as a background image, an image that has been captured in the shooting space with no humans present. The human sensing unit 15 determines whether or not there is any human by comparing the human sensing area in the background image with the human sensing area in the corrected image. The human sensing unit 15 outputs the sensing result to the controller 20 via the communications unit 16.

The communications unit 16 outputs the illuminance calculated by the illuminance acquisition unit 14 and the sensing result obtained by the human sensing unit 15 to the controller 20.

In response, the controller 20 performs light output control on the plurality of lighting fixtures 30 based on the illuminance calculated by the illuminance acquisition unit 14 and the sensing result obtained by the human sensing unit 15.

For example, the controller 20 may control the light output of the plurality of lighting fixtures 30 based on the illuminance provided by the illuminance acquisition unit 14 such that the brightness in the shooting space will have a predetermined luminance. Alternatively, the controller 20 may also compare the illuminance provided by the illuminance acquisition unit 14 with a predetermined threshold value and control the light output of the plurality of lighting fixtures 30 based on a result of the comparison. Specifically, when finding the illuminance provided by the illuminance acquisition unit 14 less than the predetermined threshold value, the controller 20 controls the light output of the plurality of lighting fixtures 30 so as to increase the light output of the plurality of lighting fixtures 30. On the other hand, when finding the illuminance provided by the illuminance acquisition unit 14 greater than the predetermined threshold value, the controller 20 controls the light output of the plurality of lighting fixtures 30 so as to decrease the light output of the plurality of lighting fixtures 30.

In addition, the controller 20 also controls the light output of the plurality of lighting fixtures 30 based on the sensing result obtained by the human sensing unit 15 (i.e., depending on whether or not there is any human in the shooting space). Specifically, if there is any human in the shooting space, the controller 20 controls the plurality of lighting fixtures 30 to turn those lighting fixtures 30 ON. On the other hand, if there are no humans in the shooting space, the controller 20 controls the plurality of lighting fixtures 30 to turn those lighting fixtures 30 OFF.

The controller 20 may control the plurality of lighting fixtures 30 in various manners by changing combinations of the illuminance provided by the illuminance acquisition unit 14 and the sensing result obtained by the human sensing unit 15.

Optionally, according to this embodiment, the illuminance acquisition area and the human sensing area may be set in advance when the illuminance acquisition device 10 is going to be shipped. In that case, the operator is expected to change the preset illuminance acquisition area and the human sensing area by inputting operating commands. The illuminance acquisition area may be the same as the human sensing area. Alternatively, the human sensing area may be included in the illuminance acquisition area. Conversely, the illuminance acquisition area may be included in the human sensing area. Still alternatively, part of the illuminance acquisition area may be included in the human sensing area. Yet alternatively, there may be no overlapping area between the illuminance acquisition area and the human sensing area. In the embodiment described above, the illuminance acquisition area is defined such that pixels are contiguous with each other in the X-axis or Y-axis direction shown in FIG. 2. However, this is only an example and should not be construed as limiting. That is to say, pixels included in the illuminance acquisition area may be discontinuous with each other in the X-axis or Y-axis direction shown in FIG. 2.

Also, in the embodiment described above, calibrations are supposed to be performed to calculate the transform coefficient when the illuminance acquisition device 10 is installed. However, this should not be construed as limiting. Rather the illuminance acquisition device 10 may also perform calibrations and update the transform coefficient even after having been installed. For example, the illuminance acquisition device 10 may update the transform coefficient at regular intervals (of, e.g., every month, every six months, or once a year) or every time the image capturing unit 1 is inspected.

Note that the image capturing unit 11 is not an essential element for the illuminance acquisition device 10. Also, the illuminance acquisition device 10 and the controller 20 may be implemented as a single integrated device.

### Second Embodiment

According to a second embodiment, the setting unit 13 has not only the function of setting an illuminance acquisition area in accordance with operating commands input by the operator but also the function of automatically setting the illuminance acquisition area, which is a major difference from the first embodiment.

The following description of the second embodiment will be focused on differences from the first embodiment. Also, in the following description, any constituent member of the second embodiment having the same function as the counterpart of the first embodiment described above will be designated by the same reference numeral as that counterpart's, and a detailed description thereof will be omitted herein.

The setting unit 13 of this embodiment has the following functions in addition to the function of setting an illuminance acquisition area in accordance with the operating commands input by the operator.

The setting unit 13 has the function of setting (or changing) the illuminance acquisition area in accordance with a variation with time in the pixel value of every pixel included in a predetermined area of an image captured (hereinafter referred to as an “area setting function”). In this case, the predetermined area may be the illuminance acquisition area specified by the operator, for example. The setting unit 13 checks each of a plurality of pixels included in the illuminance acquisition area for a variation with time in their pixel value, and removes, when finding the magnitude of the variation in the pixel value of any of the plurality of pixels greater than a predetermined threshold value, the pixel from the illuminance acquisition area. On the other hand, when finding the magnitude of the variation in the pixel value of each of those pixels less than the predetermined threshold value, the setting unit 13 regards that pixel as a pixel to be included in the illuminance acquisition area.

The area setting function of the setting unit 13 will be described with reference to

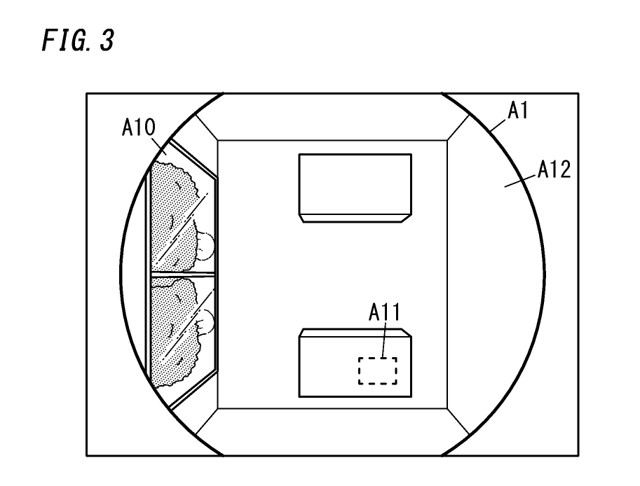

FIG. 3. Note that FIG. 3 is drawn on the supposition that the image capturing area A1 is set as the illuminance acquisition area. Also, an area A10 included in the image capturing area Al is an area within an indoor window frame. In the area A10, a view of the outdoors is captured through the window. Meanwhile, in another area A11, there is a mobile object not to be fixed in that place (hereinafter referred to as a “non-fixed object”) such as a TV remote controller. The setting unit 13 obtains the degree of variation in the pixel value of every pixel included in the image capturing area A1 as the illuminance acquisition area within a certain amount of time (of, e.g., five minutes). For example, in the area A10, the trees will be shaken or trembled by the wind or due to any other factor, thus causing frequent changes in brightness, which results in a significant variation in pixel value in the area A10. When finding the magnitude of the variation in pixel value in the area A10 greater than a predetermined threshold value, the setting unit 13 removes the area A10 from the illuminance acquisition area. Furthermore, a non-fixed object such as a remote controller is constantly moved by the human user, and therefore, may be present in the area A11 at a certain point in time but may be absent from the area A11 at another point in time. In such a situation, a pixel value in the area A11 varies depending on whether or not there is such a non-fixed object in the area A11. That is why when finding the magnitude of the variation in the pixel value in the area A11 greater than the predetermined threshold value, the setting unit 13 removes the area A11 from the illuminance acquisition area. In this manner, the setting unit 13 removes those areas A10 and All from the image capturing area A1 as the illuminance acquisition area based on the variation in the pixel value of each pixel in the image capturing area A1, thereby setting the other area A12 as the illuminance acquisition area (i.e., changing the illuminance acquisition area from the entire image capturing area A1 into the area A12). Note that the pixel value of each pixel may be obtained by the setting unit 13 or by the illuminance acquisition unit 14 without particular limitation.

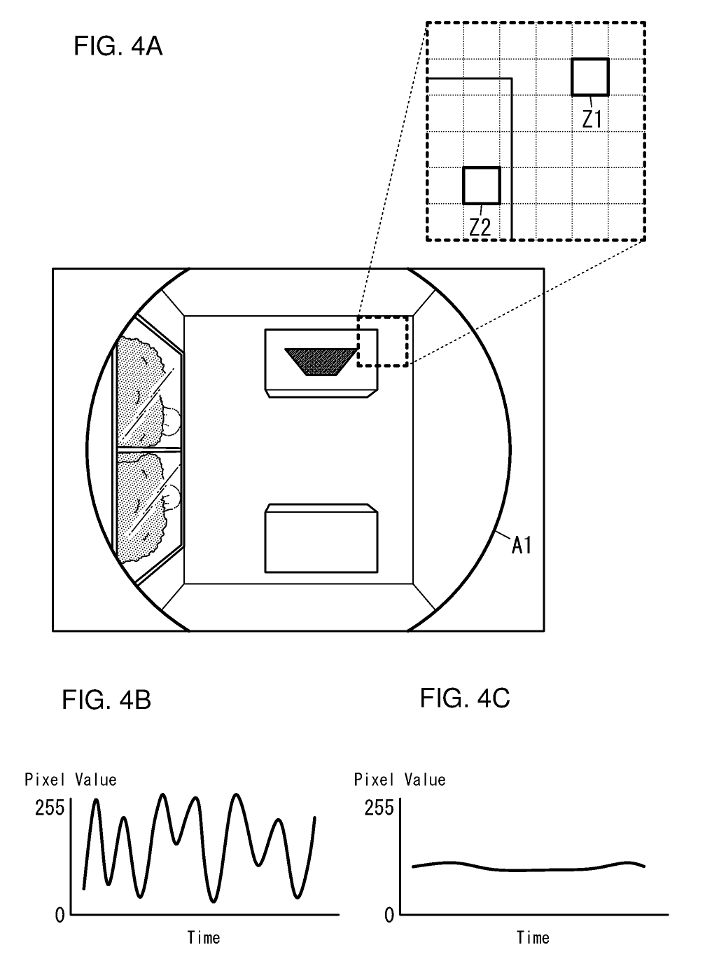

With this regard, it will be described with reference to FIGS. 4A-4C how to determine the magnitude (or the degree) of the variation in a pixel value. Note that FIG. 4A is drawn on the supposition that the image capturing area A1 is set as the illuminance acquisition area. The setting unit 13 determines the degree of the variation based on the variation in pixel value (i.e., the variance between pixel values) within a certain amount of time (of, e.g., five minutes) for every pixel included in the image capturing area A1 as the illuminance acquisition area. Specifically, when finding the variance between pixel values of a particular pixel (i.e., the variation in the pixel value within a certain amount of time) greater than a predetermined threshold value, the setting unit 13 determines that the particular pixel has a significant degree of variation. On the other hand, when finding the variance between pixel values of a particular pixel less than the predetermined threshold value, the setting unit 13 determines that the particular pixel has an insignificant degree of variation. In this case, the predetermined threshold value may be a difference value between +30% and −30% of the average of the pixel values of the particular pixel during the certain amount of time. If the difference between the maximum and minimum pixel values of the particular pixel during the certain amount of time is equal to or less than the difference value, the setting unit 13 determines that the variance is insignificant. On the other hand, if the difference is greater than the difference value, then the setting unit 13 determines that the variance is significant. Note that these numerical values are only exemplary ones and should not be construed as limiting.

For example, FIG. 4B shows a result indicating the dispersion of pixel values of the pixel Z1 shown in FIG. 4A. In FIG. 4B, the variance between pixel values (i.e., a variation in pixel value during a certain amount of time) of the pixel Z1 is significant. Therefore, when finding the variance between pixel values of the pixel Z1 greater than a predetermined threshold value, the setting unit 13 determines that the pixel Z1 has a significant degree of variation. Meanwhile, FIG. 4C shows a result indicating the dispersion of pixel values of the pixel Z2 shown in FIG. 4A. In FIG. 4C, the variance between pixel values of the pixel Z2 is insignificant. Therefore, when finding the variance between pixel values of the pixel Z2 less than a predetermined threshold value, the setting unit 13 determines that the pixel Z2 has an insignificant degree of variation.

In the embodiment described above, the setting unit 13 regards, as a predetermined area, the illuminance acquisition area that has been set in accordance with the operating commands input by the operator and changes that area. However, this is only an example and should not be construed as limiting. Alternatively, the illuminance acquisition area that has been set in advance when the illuminance acquisition device 10 is going to be shipped may be regarded as a predetermined area to be changed. Still alternatively, if no illuminance acquisition areas have been set, the setting unit 13 may set the illuminance acquisition area by regarding the image capturing area A1 as the predetermined area. Furthermore, even if an illuminance acquisition area has been set, the setting unit 13 may also newly set a different illuminance acquisition area by regarding the image capturing area A1 as the predetermined area.

This allows the illuminance acquisition device 10 of this embodiment to automatically set (or change) the illuminance acquisition area.

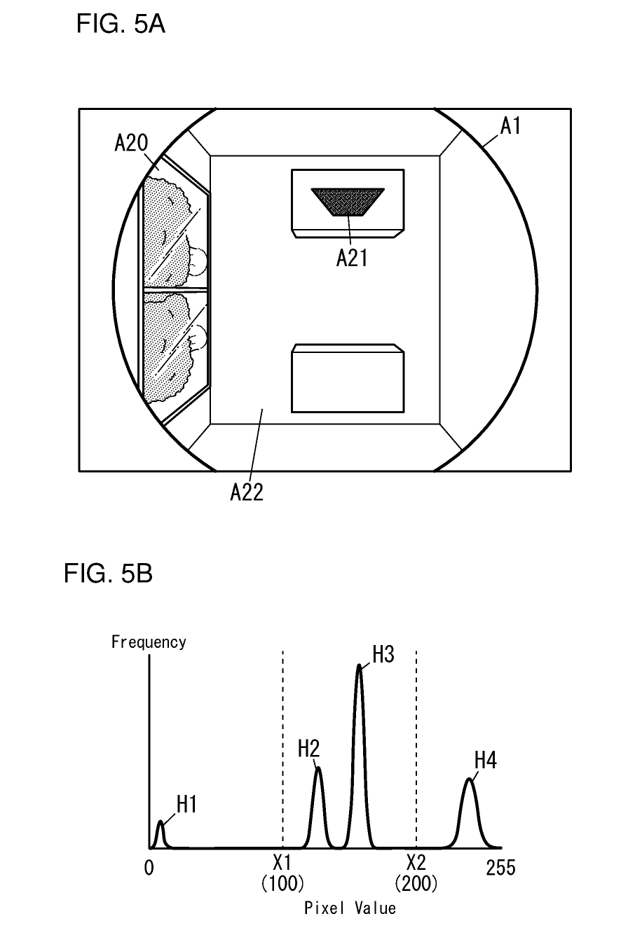

In the embodiment described above, the setting unit 13 sets (and changes) the illuminance acquisition area based on the degree of variation in the pixel value. However, this is only an example and should not be construed as limiting. Alternatively, the setting unit 13 may remove any pixel, of which the pixel value falls out of a predetermined range, from the illuminance acquisition area. Specifically, the setting unit 13 generates a histogram of pixel values with respect to a plurality of pixels included in a predetermined area. By reference to the histogram thus generated, the setting unit 13 determines a pixel with a low pixel value and a pixel with a high pixel value as pixels falling out of the predetermined range. Next, it will be described with reference to FIG. 5A and 5B how to make a decision in such a situation. FIG. 5A is drawn on the supposition that the image capturing area A1 has been set as the illuminance acquisition area and that pixel values should fall within the range of 0-255. Note that the area A20 included in the image capturing area A1, as well as the area A10 described above, is an area within the window frame, and a view of the outdoors is captured in the area A20. Also, there is an object in a dark color in the area A21.

The setting unit 13 generates a histogram of pixel values with respect to all pixels included in the image capturing area A1 of the image capturing unit 11 (see FIG. 5B). The area A21, capturing an object in a dark color, comes to have a low pixel value in itself. That is why the histogram with respect to the area A21 may be a histogram H1, of which the pixel value is less than a first threshold value X1 (e.g., a pixel value of 100) (see FIG. 5B). Meanwhile, in the area A20, a view of the outdoors is captured, and therefore, the area A20 looks brighter during the day due to sunlight or any other light source than other areas. Thus, the histogram with respect to the area A20 may be a histogram H4, of which the pixel value is greater than a second threshold value X2 (e.g., a pixel value of 200) (see FIG. 5B). Also, the histogram with respect to the other area A22, defined by removing the areas A20 and A21 from the image capturing area A1 as the illuminance acquisition area, falls within the range of the first threshold value X1 to the second threshold value X2 (e.g., see the histograms H2 and H3 shown in FIG. 5B).

The setting unit 13 removes pixels falling within the area A21, which is an area of pixels with pixel values less than the first threshold value and which includes the histogram H1, as pixels with low pixel values from the illuminance acquisition area. In addition, the setting unit 13 also removes pixels falling within the area A20, which is an area of pixels with pixel values greater than the second threshold value and which includes the histogram H4, as pixels with high pixel values from the illuminance acquisition area. Furthermore, the setting unit 13 sets the area A22, which is an area of pixels with pixel values falling within the range of the first threshold value X1 to the second threshold value X2 and which includes the histograms H2 and H3, as the illuminance acquisition area (i.e., changes the illuminance acquisition area from the entire image capturing area A1 into the area A22).

Optionally, such a change of the illuminance acquisition areas using the histogram and a change of the illuminance acquisition areas in accordance with a variation with time in pixel value as described above may be carried out in combination. In that case, the setting unit 13 checks the pixel values for their degree of variance with time, removes pixels with a significant degree of variance (with a significant degree of dispersion), and sets the illuminance acquisition area for the other pixels using a histogram (i.e., changes the illuminance acquisition areas).

Also, the setting unit 13 may also set, as the illuminance acquisition area, an area in which at least a predetermined number of pixels, among all pixels falling within the area A22 having pixel values within the range of the first threshold value X1 to the second threshold value X2 and including the histograms H2 and H3, are formed continuously. In that case, the illuminance acquisition area thus set is not made up of a plurality of dispersed areas (i.e., does not have a discontinuous distribution) but becomes a single continuous area.

Furthermore, in the embodiment described above, the lower limit value X1 and upper limit value X2 of the predetermined range are supposed to be determined in advance. However, this is only an example and should not be construed as limiting. Alternatively, the lower limit value X1 and upper limit value X2 of the predetermined range may also be set based on a histogram of pixel values generated by the setting unit 13. For example, the setting unit 13 may respectively set X1 and X2 at the lower and upper limit values of a range including 70% of the pixel values of a plurality of pixels falling within a predetermined area (such as the image capturing area A1). Note that this numerical value is only an example and should not be construed as limiting.

Moreover, even if pixels with pixel values falling out of the predetermined range are removed from the illuminance acquisition area, the illuminance acquisition area that has been set in advance when the illuminance acquisition device 10 is going to be shipped may be regarded as a predetermined area to be changed. If no illuminance acquisition areas have been set, the setting unit 13 may set the illuminance acquisition area by regarding the image capturing area A1 as the predetermined area. Furthermore, even if an illuminance acquisition area has been set, the setting unit 13 may also newly set a different illuminance acquisition area by regarding the image capturing area A1 as the predetermined area.

### CONCLUSION

As can be seen from the foregoing description of embodiments, an illuminance acquisition device 10 according to a first aspect of the present invention includes a setting unit 13, a human sensing unit 15, and an illuminance acquisition unit 14. The setting unit 13 is configured to set a first area (illuminance acquisition area) for use to acquire an illuminance in an image capturing area of an image capturing unit 11. The human sensing unit 15 is configured to determine, based on an image captured by the image capturing unit 11, whether or not there is any human in a second area (human sensing area) of the image capturing area. The illuminance acquisition unit 14 is configured to acquire, based on the image, a spatial illuminance in the first area.

According to this configuration, the illuminance acquisition device 10 sets a first area (illuminance acquisition area) in an image capturing area, and therefore, may remove, for example, an area where the pixel value varies frequently from the first area. This allows the illuminance acquisition device 10 to reduce an error in the illuminance detected from an image by using the first area.

In an illuminance acquisition device 10 according to a second aspect of the present invention, which is dependent on the first aspect, the setting unit 13 sets the first area in accordance with an operating signal supplied from an operating unit 12. According to this configuration, the illuminance acquisition device 10 sets the first area in accordance with operating commands input by an operator. This allows the operator to set the first area according to his or her own preference.

In an illuminance acquisition device 10 according to a third aspect of the present invention, which is dependent on the first or second aspect, the setting unit 13 removes, from the first area, any of a plurality of pixels included in the first area, when finding magnitude of a variation with time in its pixel value to be greater than a predetermined threshold value. According to this configuration, the illuminance acquisition device 10 removes any pixel, of which the pixel value has varied significantly with time, from the first area, thus obtaining even more appropriate illuminance (brightness).

In an illuminance acquisition device 10 according to a fourth aspect of the present invention, which is dependent on the third aspect, the setting unit 13 determines, for each of the plurality of pixels, the magnitude of the variation in the pixel value by a degree of variance with time between pixel values of that pixel. According to this configuration, the illuminance acquisition device 10 determines the degree of the variation in the pixel value by a degree of variance between the pixel values, which allows the illuminance acquisition device 10 to set the first area even more appropriately.

In an illuminance acquisition device 10 according to a fifth aspect of the present invention, which is dependent on any one of the first to fourth aspects, the setting unit 13 removes, from the first area, any of a plurality of pixels included in the first area, when finding a pixel value of the pixel to be falling out of a predetermined range. According to this configuration, the illuminance acquisition device 10 removes a pixel, of which the pixel value falls out of a predetermined range, from the first area. This allows the illuminance acquisition device 10 to obtain even more appropriate illuminance (brightness).

In an illuminance acquisition device 10 according to a sixth aspect of the present invention, which is dependent on the fifth aspect, the setting unit 13 determines a pixel with a high pixel value and a pixel with a low pixel value to be the pixels falling out of the predetermined range in a histogram of pixel values of the plurality of pixels. According to this configuration, the illuminance acquisition device 10 determines a pixel with a high pixel value and a pixel with a low pixel value to be pixels falling out of the predetermined range using a histogram of pixel values, which allows the illuminance acquisition device 10 to set the first area even more appropriately.

In an illuminance acquisition device 10 according to a seventh aspect of the present invention, which is dependent on the sixth aspect, the setting unit 13 sets, as the first area, an area in which among all of the plurality of pixels but the pixel with the high pixel value and the pixel with the low pixel value, at least a predetermined number of pixels are formed continuously. This configuration allows the illuminance acquisition device 10 to set a single continuous area as the first area.

An illumination control system 1 according to an eighth aspect of the present invention includes the illuminance acquisition device 10 according to any of the first to seventh aspects described above, a lighting fixture 30, and a controller 20. The controller 20 is configured to, when the illuminance acquisition device 10 has detected presence of any human, control light output of the lighting fixture 30 based on the illuminance acquired by the illuminance acquisition device 10. According to this configuration, the illumination control system 1 is able to reduce an error in the illuminance detected from an image by using the first area (illuminance acquisition area) set by the illuminance acquisition device 10. This allows the controller 20 of the illumination control system 1 to perform highly accurate light output control on the lighting fixture 30.

A program according to a ninth aspect of the present invention is designed to make a computer function as a setting unit 13, a human sensing unit 15, and an illuminance acquisition unit 14. The setting unit 13 is configured to set a first area for use to acquire an illuminance in an image capturing area of an image capturing unit 11. The human sensing unit 15 is configured to determine, based on an image captured by the image capturing unit 11, whether or not there is any human in a second area of the image capturing area. The illuminance acquisition unit 14 is configured to acquire, based on the image, a spatial illuminance in the first area. This program allows for reducing an error in illuminance detected from an image by using an illuminance acquisition area.

### REFERENCE SIGNS LIST

1 Illumination Control System

10 Illuminance Acquisition Device

11 Image Capturing Unit

13 Setting Unit

14 Illuminance Acquisition Unit

15 Human Sensing Unit

20 Controller

30 Lighting fixture

1. An illuminance acquisition device comprising:
a setting unit configured to set a first area for use to acquire an illuminance in an image capturing area of an image capturing unit;
a human sensing unit configured to determine, based on an image captured by the image capturing unit, whether or not there is any human in a second area of the image capturing area; and
an illuminance acquisition unit configured to acquire, based on the image, a spatial illuminance in the first area.

2. The illuminance acquisition device of claim 1, wherein
the setting unit sets the first area in accordance with an operating signal supplied from an operating unit.

3. The illuminance acquisition device of claim 1, wherein
the setting unit removes, from the first area, any of a plurality of pixels included in the first area, when finding magnitude of a variation with time in its pixel value to be greater than a predetermined threshold value.

4. The illuminance acquisition device of claim 3, wherein
the setting unit determines, for each of the plurality of pixels, the magnitude of the variation in the pixel value by a degree of variance with time between pixel values of that pixel.

5. The illuminance acquisition device of claim 1, wherein
the setting unit removes, from the first area, any of a plurality of pixels included in the first area, when finding a pixel value of the pixel to be falling out of a predetermined range.

6. The illuminance acquisition device of claim 5, wherein
the setting unit determines a pixel with a high pixel value and a pixel with a low pixel value to be the pixels falling out of the predetermined range in a histogram of pixel values of the plurality of pixels.

7. The illuminance acquisition device of claim 6, wherein
the setting unit sets, as the first area, an area in which among all of the plurality of pixels but the pixel with the high pixel value and the pixel with the low pixel value, at least a predetermined number of pixels are formed continuously.

8. An illumination control system comprising:
the illuminance acquisition device of claim 1;
a lighting fixture; and
a controller configured to, when the illuminance acquisition device has detected presence of any human, control light output of the lighting fixture based on the illuminance acquired by the illuminance acquisition device.

9. A program designed to make a computer function as:
a setting unit configured to set a first area for use to acquire an illuminance in an image capturing area of an image capturing unit;
a human sensing unit configured to determine, based on an image captured by the image capturing unit, whether or not there is any human in a second area of the image capturing area; and
an illuminance acquisition unit configured to acquire, based on the image, a spatial illuminance in the first area.
